(19) United States
(12) Patent Application Publication
(10) Pub. No.: US 2025/0159767 A1
(43) Pub. Date: May 15, 2025

(54) INDUCTION HEATER AND METHOD FOR CONTROLLING SAME

(71) Applicant: SAMSUNG ELECTRONICS CO., LTD., Suwon-si (KR)

(72) Inventors: Hongjoo KANG, Suwon-si (KR); Nokhaeng LEE, Suwon-si (KR); Jeawon LEE, Suwon-si (KR); Myoungjin HAM, Suwon-si (KR)

(73) Assignee: SAMSUNG ELECTRONICS CO., LTD., Suwon-si (KR)

(21) Appl. No.: 19/025,398

(22) Filed: Jan. 16, 2025

Related U.S. Application Data
(63) Continuation of application No. PCT/KR2023/011630, filed on Aug. 8, 2023.

(30) Foreign Application Priority Data
Aug. 17, 2022 (KR) 10-2022-0102983
Jan. 6, 2023 (KR) 10-2023-0002456

(51) Int. Cl. H05B 6/08; H05B 1/02; H05B 6/12

(52) U.S. Cl. CPC H05B 6/08; H05B 1/0202; H05B 6/12

(57) ABSTRACT

An induction heater including a heating coil; a rectifier circuit; a power factor correction (PFC) circuit; a direct current (DC) link capacitor; and an inverter circuit connected to the DC link capacitor, and apply a drive current to the heating coil. The PFC circuit includes: a first inductor and a second inductor connected to an output node of the rectifier circuit; a first diode connected to the first inductor and the DC link capacitor; a second diode connected to the second inductor and the DC link capacitor; a first switching element connected to the first inductor and a ground node; and a second switching element connected to the second inductor and the ground node.

### CROSS-REFERENCE TO RELATED APPLICATION

This application is a continuation application, under 35 U.S.C. § 111(a), of international application No. PCT/KR2023/011630, filed Aug. 8, 2023, which claims priority under 35 U. S. C. § 119 to Korean Patent Application No. 10-2022-0102983, filed on Aug. 17, 2022, and Korean Patent Application No. 10-2023-0002456, filed on Jan. 6, 2023, the disclosures of which are incorporated herein by reference in their entireties.

### TECHNICAL FIELD

The disclosure relates to an induction heater having an improved circuit configuration.

### BACKGROUND ART

In general, an induction heater is a cooking apparatus that heats and cooks a food using the principle of induction heating. The induction heater may include a cooking plate on which a cooking vessel is placed, and a heating coil that generates a magnetic field when an electric current is applied.

When current is applied to the heating coil and a magnetic field is generated, a secondary current is induced in the cooking vessel, and Joule heat is generated by an electrical resistance component of the cooking vessel itself. As a result, the cooking vessel is heated by a high frequency current, and the food in the cooking vessel is cooked.

Because an induction heater uses a cooking vessel itself as a heat source, induction heaters have higher heat transfer rates, no harmful gases, and no risk of fire, compared to gas stoves or kerosene stoves that burn fossil fuels and heat the cooking vessel through the heat of combustion.

### DISCLOSURE

### Technical Problem

An aspect of the disclosure provides an induction heater with an improved performance.

### Technical Solution

According to an aspect of the disclosure, an induction heater may include: a heating coil; a rectifier circuit configured to rectify an alternating current input power; a power factor correction (PFC) circuit connected to the rectifier circuit; a direct current (DC) link capacitor connected to the PFC circuit; and an inverter circuit connected to the DC link capacitor, and apply a drive current to the heating coil, wherein the PFC circuit includes: a first inductor connected to an output node of the rectifier circuit; a second inductor connected to the output node of the rectifier circuit and connected in parallel with the first inductor; a first diode connected to the first inductor and the DC link capacitor; a second diode connected to the second inductor and the DC link capacitor; a first switching element connected to the first inductor and a ground node; and a second switching element connected to the second inductor and the ground node. The first switching element and the second switching element may be respectively controllable to operate to allow alternating current to flow to the heating coil.

The induction heater may further include a controller configured to control the first switching element and the second switching element.

In addition, the controller may be configured to operate the first switching element and the second switching element to be complementary with each other, based on receiving a user input to turn on the induction heater.

In addition, the controller may be configured to control the first switching element and the second switching element to allow a switching frequency to be 30 kHz or more.

In addition, the inverter circuit may include an upper switching element and a lower switching element, and the controller may be configured to determine switching frequencies of the upper switching element and the lower switching element based on an operation setting of the heating coil, and operate the upper switching element and the lower switching element in a complementary manner according to the determined switching frequencies.

In addition, the DC link capacitor may include a plurality of capacitors connected to each other.

In addition, the inverter circuit may include an upper switching element, a lower switching element, an upper resonant capacitor and a lower resonant capacitor, and the heating coil may be connected between a common node of the upper resonant capacitor and the lower resonant capacitor and a common node of the upper switching element and the lower switching element.

In addition, an anode of the first diode is a common node of the first inductor, the first diode and the first switching element.

In addition, an anode of the second diode is a common node of the second inductor, the second diode and the second switching element.

In addition, the DC link capacitor may be connected to a cathode of the first diode and the ground node.

In addition, the DC link capacitor may be connected to a cathode of the second diode and the ground node.

In addition, the inverter circuit may include: an upper switching element connected to a cathode of the first diode or a cathode of the second diode and a first node; and a lower switching element connected to the first node and the ground node.

According to an aspect of the disclosure, in a method for controlling an induction heater including rectifying, using a rectifier circuit, alternating current input power, a the rectifier circuit being connected to power factor correction (PFC) circuit which is connected to a direct current (DC) link, the DC link capacitor being connected to an inverter circuit to apply a drive current to a heating coil. The method may include operating a first switching element of the PFC circuit and a second switching element of the PFC circuit to be complementary with each other, based on receiving a user input to turn on the induction heater, the first switching element and the second switching element being connected to a ground node.

The first switching element and the second switching element may be connected to a ground node. Where the PFC circuit may include: a first inductor connected to an output node of the rectifier circuit, the first inductor being connected to the first switching element; a second inductor connected to the output node of the rectifier circuit and connected in parallel with the first inductor, the second inductor being connected to the second switching element; a first diode connected to the first inductor and the DC link capacitor; a second diode connected to the second inductor and the DC link capacitor.

In addition, the operating of the first switching element and the second switching element to be complementary with each other may include controlling the first switching element and the second switching element to allow a switching frequency to be 30 kHz or more.

In addition, the inverter circuit may include an upper switching element and a lower switching element, and the method may further include: determining switching frequencies of the upper switching element and the lower switching element based on an operation setting of the heating coil; and operating the upper switching element and the lower switching element in a complementary manner according to the determined switching frequencies.

### Advantageous Effects

According to an aspect of the disclosure, noise generated during operation of an induction heater may be suppressed.

According to an aspect of the disclosure, a heating performance of a small cooking vessel or cooking vessel made of low permeability materials may be improved.

### DESCRIPTION OF DRAWINGS

FIG. 1 is a view of an exterior of an induction heater according to an embodiment of the disclosure.

FIG. 2 is a view illustrating an inside of an induction heater according to an embodiment of the disclosure.

FIG. 3 is a diagram illustrating a principle by which an induction heater heats a cooking vessel according to an embodiment of the disclosure.

FIG. 4 is a control block diagram of an induction heater according to an embodiment of the disclosure.

FIG. 5 is a block diagram of a coil driver circuit according to an embodiment of the disclosure.

FIG. 6 illustrates an example of a coil driver circuit according to an embodiment of the disclosure.

FIG. 7 and FIG. 8 illustrate examples of current flow when an input voltage has a positive value in a coil driver circuit according to an embodiment.

FIG. 9 and FIG. 10 illustrate examples of current flow when an input voltage has a negative value in a coil driver circuit according to an embodiment.

FIG. 11 is a flowchart of an example method for controlling an induction heater according to an embodiment.

### MODES OF THE INVENTION

The embodiments described in the specification and the configurations shown in the drawings are only examples of preferred embodiments of the disclosure, and various modifications may be made at the time of filing of the disclosure to replace the embodiments and drawings of the specification.

The terms used herein are for the purpose of describing the embodiments and are not intended to restrict and/or to limit the disclosure.

For example, the singular expressions herein may include plural expressions, unless the context clearly dictates otherwise.

In addition, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc., may be used herein to describe various components, these components should not be limited by these terms. These terms are only used to distinguish one component from another.

The terms, such as “˜part”, “˜device”, “˜block”, “˜member”, “˜module”, and the like may refer to a unit for processing at least one function or act. For example, the terms may refer to at least process processed by at least one hardware, such as field-programmable gate array (FPGA)/application specific integrated circuit (ASIC), software stored in memories, or processors.

Hereinafter, an embodiment of the disclosure will be described in detail with reference to the accompanying drawings. Identical symbols or numbers in the drawings of the disclosure denote components or elements configured to perform substantially identical functions.

Hereinafter, the operation principle and embodiments of the disclosure will be described with reference to the accompanying drawings.

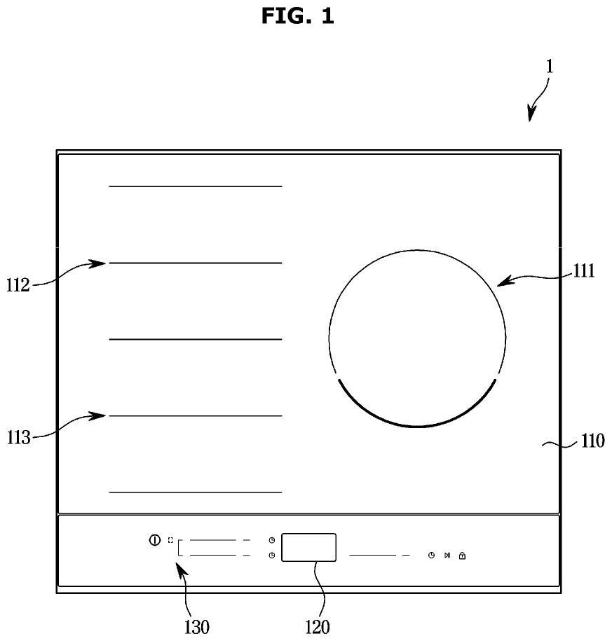

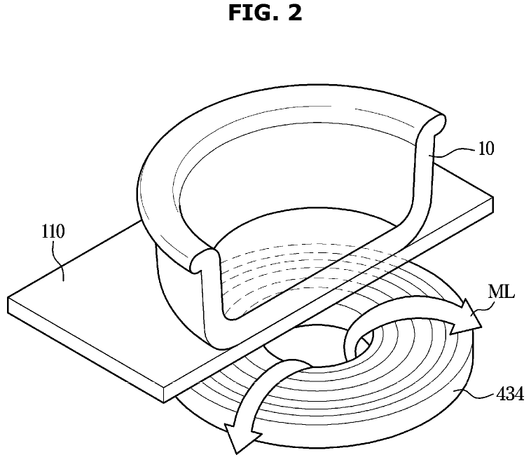

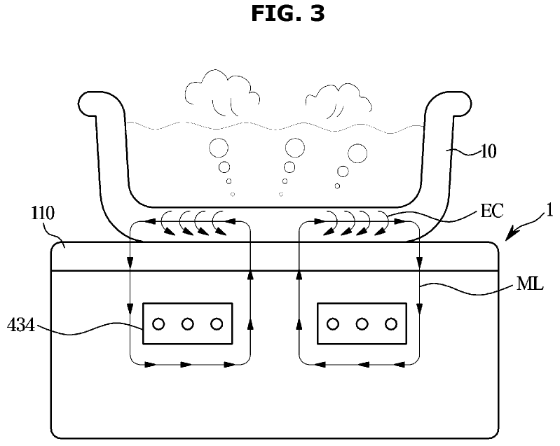

FIG. 1 is a view of an exterior of an induction heater according to an embodiment. FIG. 2 and FIG. 3 illustrate a heating principle of an induction heater according to an embodiment.

FIG. 1 is a view of an exterior of an induction heater according to an embodiment. FIG. 2 and FIG. 3 illustrate a heating principle of an induction heater according to an embodiment.

In FIG. 1, a top view of an induction heater 1 according to an embodiment is illustrated. As shown in FIG. 1, the induction heater 1 according to an embodiment may include a plate 110 provided on an upper portion thereof, cooking zones 111, 112, and 113 formed on the plate 110, and user interfaces 120 and 130 serving as input/output devices. For example, the plate 110 may be implemented with ceramic.

The cooking zones 111, 112, and 113 may represent positions in which the cooking vessels may be placed, and may be indicated in a circular shape (denoted by a reference numeral 111) or in a straight boundary line (denoted by reference numerals 112 and 113) to guide proper arrangement of the cooking vessels.

However, the above-described shapes are only examples of shapes for representing the cooking zones 111, 112, and 113, and without being limited to a circular or straight shape, various shapes may be applied to embodiments of the induction heater 1 as long as it may guide the user to the position of the cooking zone.

In addition, the present example is illustrated as having three cooking zones on the plate 110, but the embodiment of the induction heater 1 is not limited thereto. Only one cooking zone may be formed, and four or more cooking zones may be formed.

In one area of the plate 110, a display 120 and an input device 130 may be provided. The display 120 may include a display device, such as a liquid crystal display (LCD) or a light emitting diode (LED), and the input device 130 may include at least one of various input devices, such as a touch pad, a button, or a jog shuttle. Alternatively, the display 120 and the input device 130 may be implemented as a touch screen.

In the present example, a case in which the display 120 and the input device 130 are provided at positions spaced apart from the cooking zones 111, 112, and 113 on the plate 110 is illustrated. However, the arrangement shown in FIG. 1 is only an example applicable to the induction heater 1, and the display 120 or the input device 130 may be placed at a position other than on the plate 110, such as on the front of the induction heater 1.

Referring to FIG. 2 and FIG. 3, a heating coil 434 used to heat a vessel 10 placed on the plate 110 may be disposed below the plate 110. For convenience of description, only one heating coil 434 is illustrated in FIG. 2 and FIG. 3, but the heating coil 434 may be provided corresponding in number to the number of cooking zones.

In a case where three cooking zones 111, 112, and 113 are provided as shown in the example of FIG. 1, the heating coil 434 may be provided as three heating coils 434, and each of the heating coils 434 may be placed below a corresponding one of the cooking zones 111, 112, and 113.

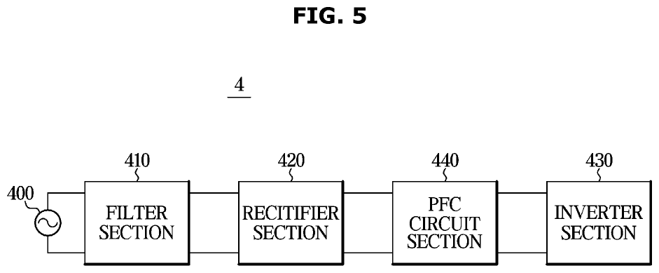

The heating coil 434 may be connected to a coil driver circuit 4 (FIG. 5) to be described below, and may be supplied with a high frequency current from the coil driver circuit 4. For example, the frequency of the high frequency current may be in a range of 20 kHz to 35 kHz.

When the heating coil 434 is supplied with a high frequency current, magnetic force lines ML may be formed in or around the heating coil 434. In a case where the vessel 10 having resistance is located within a range where the magnetic force lines ML reach, the magnetic force lines ML around the heating coil 434 may pass through the bottom of the vessel 10, generating an induced current in the form of a vortex according to the law of electromagnetic induction, i.e., eddy currents (EC).

The eddy current EC may interact with the electrical resistance of the vessel 10, generating heat in or on the vessel 10, and the generated heat may heat the food inside the vessel 10.

In the induction heater 1, the vessel 10 itself acts as a heat source, and a metal having a resistance of a certain level or higher, such as iron, stainless steel, or nickel, may be used as a material of the vessel 10.

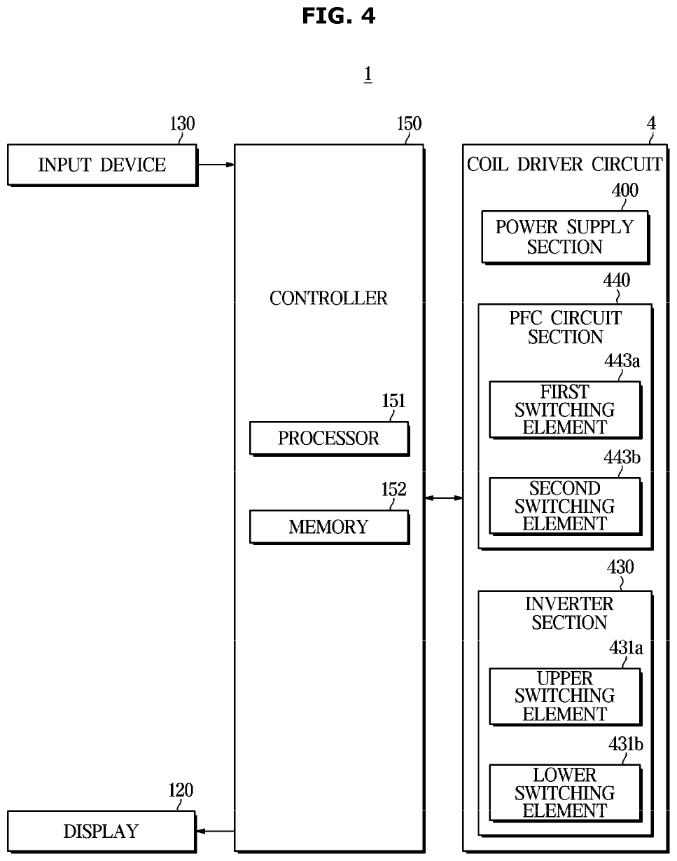

FIG. 4 is a control block diagram of an induction heater according to an embodiment. FIG. 5 is a block diagram of a coil driver circuit according to an embodiment.

Referring to FIG. 4, the induction heater 1 according to an embodiment may include the coil driver circuit 4 for supplying a drive current to the heating coil 434 described above.

The coil driver circuit 4 may include a power supply section 400 that supplies power for heating the vessel 10 to the heating coil 434 and a circuit configuration for converting the power supplied from the power supply section 400 into an alternating current (AC) and supplying the AC to the heating coil 434.

Referring to FIG. 5, in an embodiment, the coil driver circuit 4 may include a filter section 410 removing noise components included in the power supplied from the power supply section 400, a rectifier section 420 converting an AC voltage supplied from the power supply section 400 into a direct current (DC) voltage, a power factor correction (PFC) circuit section 440 (hereinafter referred to as the ‘PFC circuit section’), and an inverter section 430.

The power supply section 400 may provide an AC voltage to the coil driver circuit 4.

To this end, the power supply section 400 may include an external power source and/or a switch for blocking or allowing an external power source.

The filter section 410 may include a filter circuit including a transformer and a capacitor, and may remove noise mixed into the power supplied from the power supply section 400.

The rectifier section 420 may include a rectifier circuit, and may convert the AC voltage supplied from the power supply section 400 into a DC voltage. That is, the rectifier section 420 may rectify an AC input power.

To this end, the rectifier section 420 may include a bridge rectifier circuit including a plurality of diodes. For example, the bridge rectifier circuit may include four diodes. The diodes may form diode pairs in which two diodes are connected in series, and the two diode pairs may be connected in parallel with each other. The bridge diode may convert an AC voltage whose polarity changes with time into a voltage whose polarity is constant, and may convert an AC current whose direction changes with time into a current whose direction is constant.

According to various embodiments, the rectifier section 420 may not include a DC link capacitor.

In an embodiment, an output terminal of the rectifier section 420 may be connected to the PFC circuit section 440, not to the DC link capacitor.

The PFC circuit section may include an interleaved boost PFC circuit configuration.

The PFC circuit section may improve a power factor of the output power supplied by the output terminal of the rectifier section 420 to approach 1.

To this end, the PFC circuit section may include at least two inductors connected in parallel with each other, at least two diodes connected to the at least two inductors, and at least two switching elements 443a and 443b connected to the at least two inductors.

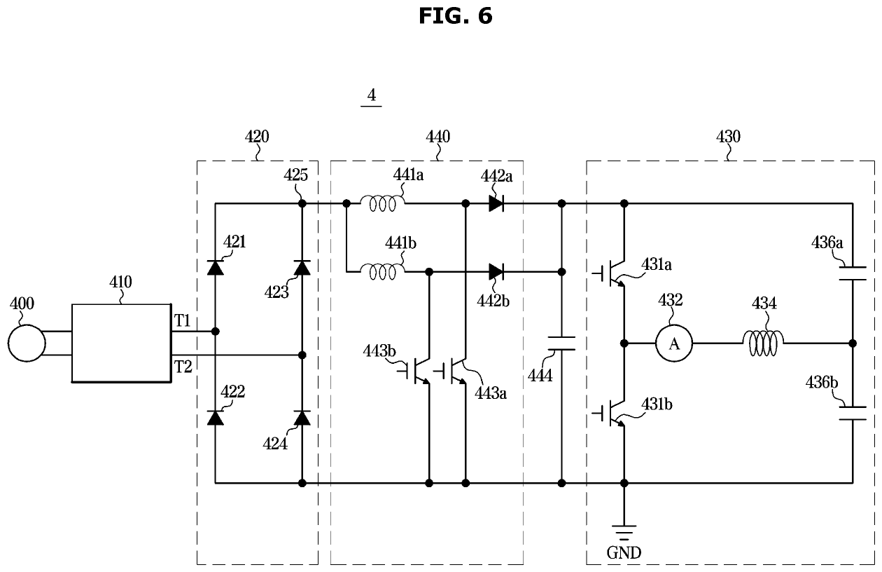

The at least two inductors may include a first inductor 441a (see FIG. 6) and a second inductor 441b (see FIG. 6), and the at least two switching elements 443a and 443b may include the first switching element 443a connected to the first inductor 441a and the second switching element 443b connected to the second inductor 441b.

The first switching element 443a and the second switching element 443b may be operated to be complementary with each other, thereby improving the power factor of the voltage rectified by the rectifier section 420. Operating the two switching elements in a complementary manner may refer to turning the two switching elements on and off alternately. In other words, operating the two switching elements in a complementary manner may include operating the two switching elements with a phase difference of 180 degrees.

The first switching element 443a and the second switching element 443b may be turned on and off by a switch driving signal. In this instance, the switch driving signal may be provided by the controller 150, and the controller 150 may smooth the voltage rectified by the rectifier section 420 by alternately turning the first switching element 443a and the second switching element 443b on and off alternately.

The first switching element 443a and the second switching element 443b may be implemented as a three-terminal semiconductor device switch having a fast response speed so as to be turned on/off at a high speed. For example, the first switching element 443a and the second switching element 443b may be provided as a bipolar junction transistor (BJT), a metal-oxide-semiconductor field effect transistor (MOSFET), an insulated gate bipolar transistor (IGBT) or a thyristor.

According to various embodiments, the PFC circuit section 440 may be connected to a DC link capacitor 444, and a voltage smoothed by the PFC circuit section 440 and the DC link capacitor 444 may be provided to the inverter section 430.

The inverter section 430 may include an upper switching element 431a and a lower switching element 431b.

The upper switching element 431a and the lower switching element 431b may operate in a complementary manner to each other to allow an AC to flow to the heating coil 434.

The upper switching element 431a and the lower switching element 431b may be turned on/off by a switch driving signal. In this instance, the switch driving signal may be provided by the controller 150, and the controller 150 may supply a high frequency alternating current to the heating coil 434 by alternately turning on/off the upper switching element 431a and the lower switching element 431b.

The upper switching element 431a and the lower switching element 431b may be implemented as a three-terminal semiconductor device switch having a fast response speed so as to be turned on/off at a high speed. For example, the upper switching element 431a and the lower switching element 431b may be provided as a bipolar junction transistor (BJT), a metal-oxide-semiconductor field effect transistor (MOSFET), an insulated gate bipolar transistor (IGBT) or a thyristor.

In addition, the coil driver circuit 4 may include a current sensor 432 (see FIG. 6) detecting the current supplied to the heating coil 434.

On a current path between a contact point of the upper switching element 431a and the lower switching element 431b and the heating coil 434, the current sensor 432 may be installed. The current sensor 432 may detect a magnitude of a current flowing through the heating coil 434 or a magnitude of a drive current supplied to the heating coil 434.

The current sensor 432 may include a current transformer to proportionally reduce the magnitude of the drive current supplied to the heating coil 434 and an ampere meter to detect the magnitude of the proportionally reduced current.

Information about the magnitude of the current detected by the current sensor 432 may be provided to the controller 150. The controller 150 may adjust the magnitude of high frequency current applied to the heating coil 434 based on the information about the magnitude of the detected current.

In addition, the controller 150 may identify whether the vessel 10 is located on the heating coil 434 based on the information about the magnitude of the detected current. For example, it may be identified that the vessel 10 is located on the heating coil 434 in response to the magnitude of the detected current being lower than a reference value. Conversely, the controller 150 may identify that the vessel 10 is not located on the heating coil 434 in response to the magnitude of the detected current being greater than or equal to the reference value.

The controller 150 may, upon identifying that the vessel 10 is not located on the heating coil 434 while the high frequency current is being applied to the heating coil 434, may cut off the high frequency current applied to the heating coil 434, thereby improving a stability of the induction heater 1.

Meanwhile, the controller 150 may identify whether the vessel 10 is located on the heating coil 434 before performing an operation of applying a high frequency current to the heating coil 434, that is, before entering a heating mode, and upon identifying that the vessel 10 is not located on the heating coil 434, may prevent the high frequency current from being applied to the heating coil 434. That is, a high frequency current may be applied to the heating coil 434 only when the vessel 10 is located on the heating coil 434.

The induction heater 1 according to an embodiment may include the controller 150 to control the operation of the induction heater 1. The controller 150 may include at least one memory 152 in which a program for performing an operation described below is stored and at least one processor 151 to execute the stored program.

The at least one processor 151 may include a microprocessor. A microprocessor is a processing device in which an arithmetic logic operator, a register, a program counter, a command decoder, a control circuit, and the like are provided in at least one silicon chip.

The microprocessor may include a graphic processing unit (GPU) for graphic processing of images or videos. The microprocessor may be implemented in the form of a system on chip (SoC) including a core and a GPU. The microprocessor may include a single core, a dual core, a triple core, a quad core, and a core of multiples thereof.

In addition, the at least one processor 151 may include an input/output processor to mediate data access between various components included in the induction heater 1 and the controller 150.

The at least one memory 152 may include a non-volatile memory, such as a read only memory (ROM), a high-speed random access memory (RAM), a magnetic disk storage device, or a flash memory device, or other types of non-volatile semiconductor memory devices.

For example, the at least one memory 152 may be a semiconductor memory device, including at least one of a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF), a multi-media card (MMC), an MMC micro, or an extreme Digital (XD) card.

In addition, the at least one memory 152 may include a network attached storage device that allows an access through a network.

The controller 150 may control the induction heater 1 based on a user input received through the input device 130. For example, the input device 130 may receive a user input related to power on/off, selection of the cooking zones 111, 112, and 113, selection of a heating intensity of the selected cooking zone(s), setting of a timer, and the like.

For example, the controller 150 may select a heating coil 434 to be supplied with high frequency power according to a selection of a cooking zone received by the input device 130, and may adjust an intensity of a magnetic field generated by the heating coil 434 according to a selection of the heating intensity received by the input device 130. In a case where the induction heater 1 includes a single cooking zone, a heating intensity may be directly selected without selecting a cooking zone.

When the input device 130 receives a selection for a heating intensity from a user, the controller 150 may determine switching frequencies of the upper switching element 431a and the lower switching element 431b based on the selected heating intensity. The controller 150 may alternately turn on/off the upper switching element 431a and the lower switching element 431b according to the determined on/off frequency, thereby applying, to the heating coil 434, a high frequency current having a frequency corresponding to the selected heating intensity.

When the input device 130 receives a selection for starting heating from the user, the controller 150 may control the power supply section 400 to supply power of the power supply section 400 to the coil driver circuit 4.

The display 120 may display information about a current state of the induction heater 1, information for guiding selection of cooking zone(s) and/or heating intensity, and information for guiding timer setting. In addition, the display 120 may display a notification indicating whether the vessel 10 is present.

According to the disclosure, the PFC circuit section 440 may be connected between the rectifier section 420 and the inverter section 430, thereby suppressing noise generated during operation of the induction heater 1.

FIG. 6 illustrates an example of a coil driver circuit according to an embodiment of the disclosure.

Referring to FIG. 6, the coil driver circuit 4 according to an embodiment may include the power supply section 400, the filter circuit 410, the rectifier circuit 420, the PFC circuit 440, the DC link capacitor 444, and the inverter circuit 430.

The filter circuit 410, the rectifier circuit 420, the PFC circuit 440, and the inverter circuit 430 refer to circuit configurations corresponding to the filter section 410, the rectifier section 420, the PFC circuit section 440, and the inverter section 430 of FIG. 5, respectively.

The power supply section 400 is an AC power source and may supply power corresponding to a rated voltage.

For example, the rated voltage may correspond to 100 V to 240 V, but examples of the rated voltage are not limited thereto.

The filter circuit 410 may include a capacitor and an inductor between an input terminal and an output terminal, and the inductor may block a passage of high frequency noise, and the capacitor may bypass the high frequency noise to the power supply section 400.

In addition, depending on embodiments, the filter circuit 410 may include at least one of a common mode filter, a normal mode filter, an across the line capacitor (X-CAP), a line bypass capacitor (Y-CAP), or a varistor.

The AC power with high frequency noise blocked by the filter circuit 410 may be supplied to the rectifier circuit 420.

The rectifier circuit 420 may convert the AC power into DC power. The rectifier circuit 420 may convert an AC voltage whose magnitude and polarity (positive voltage or negative voltage) change with time into a DC voltage whose magnitude and polarity are constant, and may convert an AC current whose magnitude and direction (positive current or negative current) change with time into a DC current whose magnitude and direction are constant.

To this end, the rectifier circuit 420 may include a bridge diode. For example, the rectifier circuit 420 may include four diodes 421, 422, 423, and 424. The diodes may form two diode pairs 421/422 and 423/424 with each connected in series. The two diode pairs may be connected in parallel with each other. The bridge diode may convert an AC voltage whose polarity changes with time into a positive voltage whose polarity is constant, and may convert an AC current whose direction changes with time into a positive current whose direction is constant.

The rectifier circuit 420 may include the diode pair 421 and 422 connected to a first terminal T1 of the power supply section 400 and the diode pair 423 and 424 connected to a second terminal T2 of the power supply section 400.

The rectifier circuit 420 may include an output node 425 and a ground node GND.

The output node 425 may refer to a node corresponding to the cathodes of the upper diodes 421 and 423.

The ground node GND may refer to a node corresponding to the anodes of the lower diodes 422 and 424.

The PFC circuit 440 may be connected between the output node 425 and the ground node GND.

Accordingly, power rectified through the rectifier circuit 420 may be applied to the PFC circuit 440.

In an embodiment, the PFC circuit 440 may include a plurality of inductors 441a and 441b, a plurality of diodes 442a and 442b, and a plurality of switching elements 443a and 443b.

According to various embodiments, the PFC circuit 440 may include the first inductor 441a connected to the output node 425 of the rectifier circuit 420, the second inductor 441b connected to the output node 425 of the rectifier circuit 420 and connected in parallel with the first inductor 441a, the first diode 442a connected to the first inductor 441a and the DC link capacitor 444, the second diode 442b connected to the second inductor 441b and the DC link capacitor 444, the first switching element 443a connected to the first inductor 441a and the ground node GND, and the second switching element 443b connected to the second inductor 441b and the ground node GND.

The first switching element 443a may include a control terminal (e.g., gate terminal) to which a control signal is applied, a first terminal (e.g., source terminal) connected to the first inductor 441a, and a second terminal (e.g., drain terminal) connected to the ground node GND.

The second switching element 443b may include a control terminal (e.g., gate terminal) to which a control signal is applied, a first terminal (e.g., source terminal) connected to the second inductor 441b, and a second terminal (e.g., drain terminal) connected to the ground node GND.

One end of the first inductor 441a may be connected to the output node 425 of the rectifier circuit 420, and the other end may be connected to an anode of the first diode 442a and the first terminal of the first switching element 443a.

One end of the second inductor 441b may be connected to the output node 425 of the rectifier circuit 420, and the other end may be connected to an anode of the second diode 442b and the source terminal of the second switching element 443b.

An inductance value of the first inductor 441a and an inductance value of the second inductor 441b may be preset based on a capacitance value of the DC link capacitor 444.

The anode of the first diode 442a may be connected to the first inductor 441a and the first switching element 443a.

A cathode of the first diode 442a may be connected to the DC link capacitor 444.

The anode of the second diode 442b may be connected to the second inductor 441b and the second switching element 443b.

A cathode of the second diode 442b may be connected to the DC link capacitor 444.

One end of the DC link capacitor 444 may be connected to the first diode 442a and the second diode 442b, and the other end may be connected to the ground node GND.

The DC link capacitor 444 may be positioned between the PFC circuit 440 and the inverter circuit 430.

According to various embodiments, the DC link capacitor 444 may include a plurality of capacitors connected to each other. For example, the DC link capacitor 444 may include a plurality of capacitors connected in parallel to each other.

According to the disclosure, the coil driver circuit 4 includes the PFC circuit 440 including the plurality of inductors 441a and 441b, the plurality of diodes 442a and 442b, and the plurality of switching elements 443a and 443b, thereby improving noise performance during operation of the heating coil 434.

In addition, according to the disclosure, the DC link capacitor 444 is positioned between the PFC circuit 440 and the inverter circuit 430, thereby improving noise performance during operation of the heating coil 434.

The inverter circuit 430 may include the upper switching element 431a and the lower switching element 431b.

The upper switching element 431a may include a control terminal (e.g., gate terminal) to which a control signal is applied, a first terminal (e.g., source terminal) connected to one end of the DC link capacitor 444, and a second terminal (e.g., drain terminal) connected to the lower switching element 431b.

The lower switching element 431b may include a control terminal (e.g., gate terminal) to which a control signal is applied, a first terminal (e.g., source terminal) connected to the second terminal of the upper switching element 431a, and a second terminal (e.g., drain terminal) connected to the ground node GND.

The heating coil 434 may be connected to a common node of the upper switching element 431a and the lower switching element 431b.

According to various embodiments, the current sensor 432 for measuring the current applied to the heating coil 434 may be provided at the common node of the upper switching element 431a and the lower switching element 431b.

According to various embodiments, the inverter circuit 430 may further include an upper resonant capacitor 436a and a lower resonant capacitor 436b.

One end of the upper resonant capacitor 436a may be connected to the first terminal of the first switching element 443a, and the other end may be connected to the lower resonant capacitor 436b.

One end of the lower resonant capacitor 436b may be connected to the upper resonant capacitor 436a, and the other end may be connected to the ground node GND.

A common node of the upper resonant capacitor 436a and the lower resonant capacitor 436b may be connected to the heating coil 434.

In an embodiment, the heating coil 434 may be connected between a common node of the first switching element 443a and the second switching element 443b and a common node of the upper resonant capacitor 436a and the lower resonant capacitor 436b.

The controller may control switching operations of the first switching element 443a and the second switching element 443b of the PFC circuit 440.

In addition, the controller may control switching operations of the upper switching element 431a and the lower switching element 431b of the inverter circuit 430.

According to the disclosure, the power whose power factor is improved by the PFC circuit 440 is applied to the heating coil 434 through the inverter circuit 430, thereby improving noise performance due to the driving of the heating coil 434.

In addition, according to the disclosure, the heating coil 434 is connected between boost capacitors, thereby improving the output power applied to the heating coil 434.

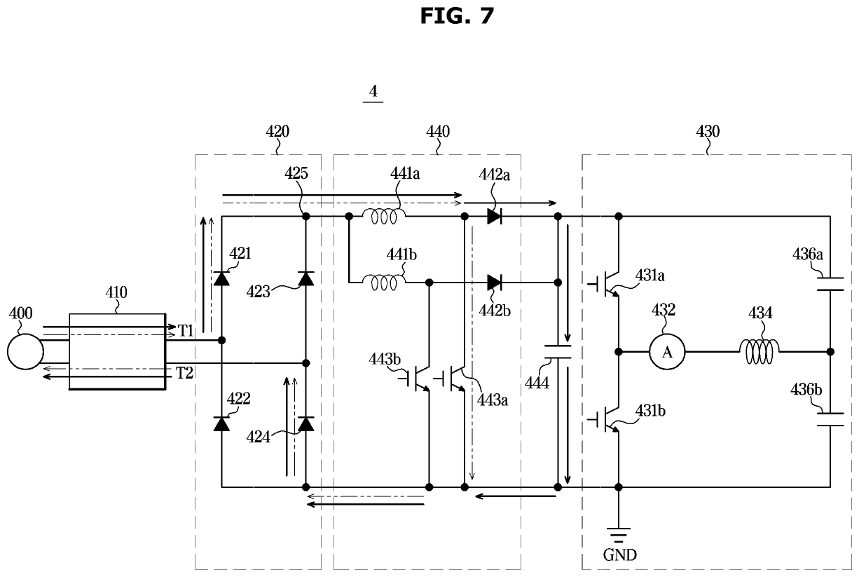

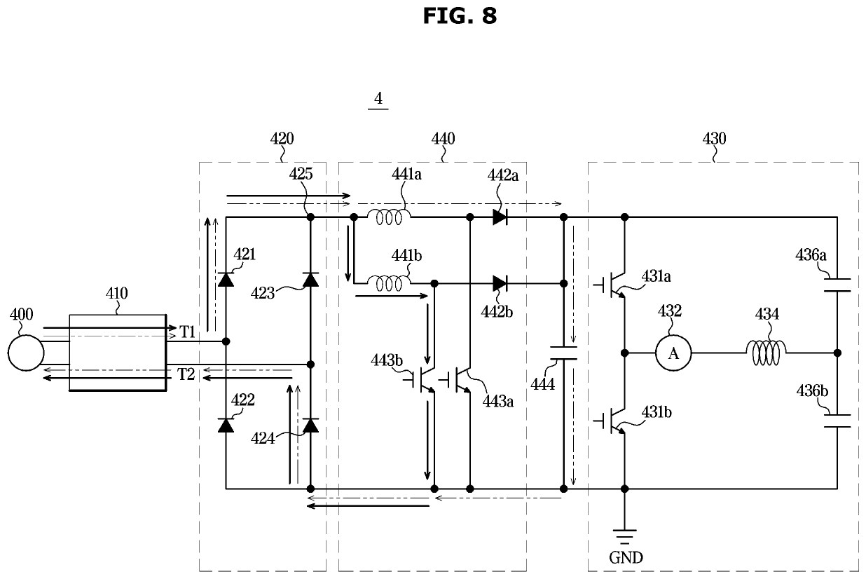

FIG. 7 and FIG. 8 illustrate examples of current flow when an input voltage has a positive value in a coil driver circuit according to an embodiment.

Referring to FIG. 7, a current flow in the coil driver circuit 4 when an input voltage has a positive value may be confirmed.

The input voltage having a positive value may indicate that a positive voltage is applied to the first terminal T1 of the power supply section 400. As described above, the first terminal T1 of the power supply section 400 may be connected to the diode pair 421 and 422.

On the other hand, an input voltage having a negative value may indicate that a positive voltage is applied to the second terminal T2 of the power supply section 400. As described above, the second terminal T2 of the power supply section 400 may be connected to the diode pair 423 and 424.

When the input voltage has a positive value, an input current may be applied to the output node 425 through the diode 421.

As shown in FIG. 7, in a case where the first switching element 443a is turned on and the second switching element 443b is turned off, the input current may flow to the ground node GND through the first inductor 441a and the first switching element 443a. In addition, the input current may flow to the ground node GND through the first inductor 441a, the first diode 442a, and the DC link capacitor 444.

As shown in FIG. 8, in a case where the second switching element 443b is turned on and the first switching element 443a is turned off, the input current may flow to the ground node GND through the second inductor 441b and the second switching element 443b. In addition, the input current may flow to the ground node GND through the first inductor 441a, the first diode 442a, and the DC link capacitor 444.

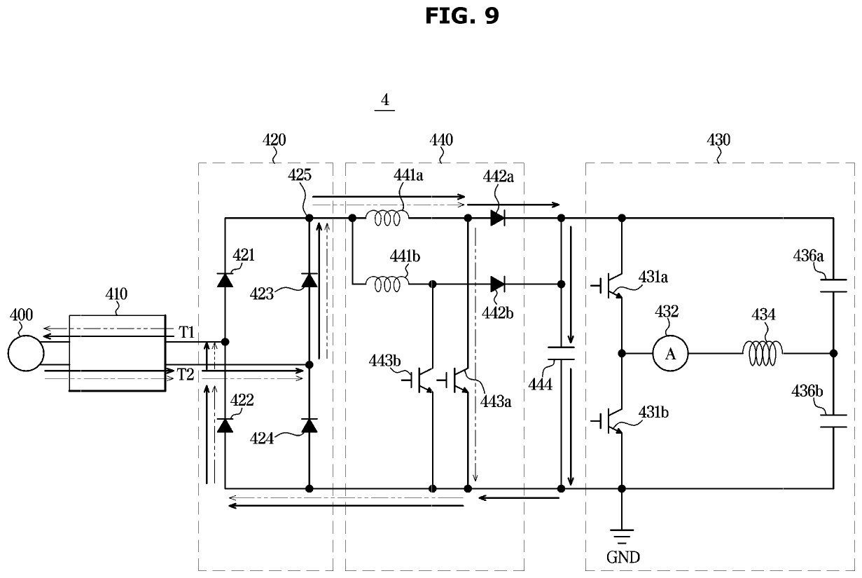

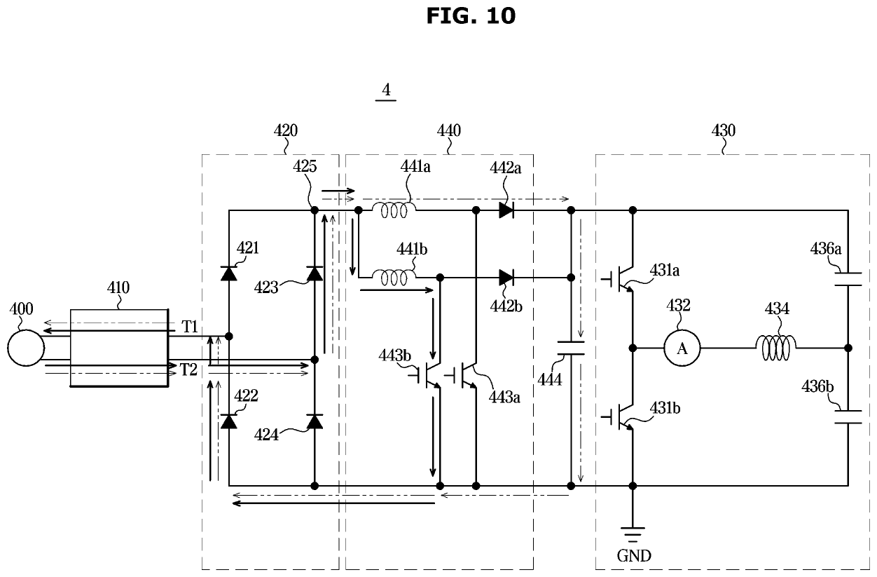

FIG. 9 and FIG. 10 illustrate examples of current flow when an input voltage has a negative value in a coil driver circuit according to an embodiment.

When an input voltage has a negative value, an input current may be applied to the output node 425 through the diode 423.

As shown in FIG. 9, in a case where the first switching element 443a is turned on and the second switching element 443b is turned off, the input current may flow to the ground node GND through the first inductor 441a and the first switching element 443a. In addition, the input current may flow to the ground node GND through the first inductor 441a, the first diode 442a, and the DC link capacitor 444.

As shown in FIG. 10, in a case where the second switching element 443b is turned on and the first switching element 443a is turned off, the input current may flow to the ground node GND through the second inductor 441b and the second switching element 443b. In addition, the input current may flow to the ground node GND through the first inductor 441a, the first diode 442a, and the DC link capacitor 444.

According to various embodiments, the controller 150 may operate the first switching element 443a and the second switching element 443b in a complementary manner.

According to the disclosure, the power smoothed by the DC link capacitor 444 may be provided to the inverter circuit 430, thereby reducing noise generated while the heating coil 434 operates.

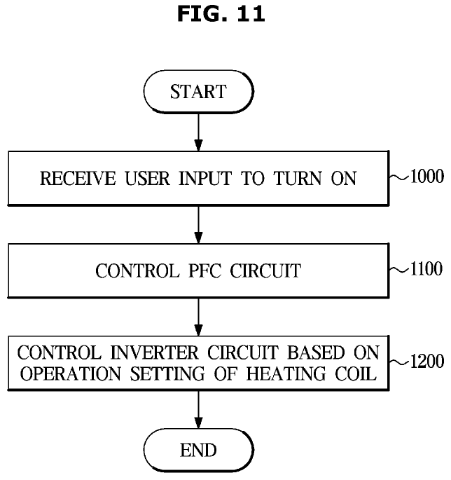

FIG. 11 is a flowchart of an example method for controlling an induction heater according to an embodiment.

A user may input a command to turn on the induction heater 1 through the input device 130.

For example, the input device 130 may include a power button, and the user may input a command to turn on the induction heater 1 by selecting the power button.

The controller 150 may receive a user input to turn on the induction heater 1 through the input device 130 (1000).

The controller 150 may control the PFC circuit 440 (1100), in response to receiving the user input to turn on the induction heater 1.

For example, the controller 150 may operate the first switching element 443a and the second switching element 443b in a complementary manner in response to receiving the user input to turn on the induction heater.

According to various embodiments, operating frequencies of the first switching element 443a and the second switching element 443b may be preset and may be set to 30 kHz or more.

That is, the controller 150 may control the first switching element 443a and the second switching element 443b to allow a switching frequency to become 30 kHz or more, in response to receiving the user input to turn on the induction heater.

According to various embodiments, while the first switching element 443a and the second switching element 443b are operating in a complementary manner, the upper switching element 431a and the lower switching element 431b of the inverter circuit 430 may not operate.

In response to receiving the user input to turn on the induction heater, the controller 150 may operate the first switching element 443a and the second switching element 443b in a complementary manner for a preset time, while not operating the inverter circuit 430.

According to the disclosure, in a case where the power of the induction heater is first turned on, an AC voltage rectified by the rectifier section 420 may be smoothed in the DC link capacitor 444 through the switching operation of the first switching element 443a and the second switching element 443b.

The controller 150 may identify an operation setting of the heating coil 434 in response to receiving the user input to turn on the induction heater. The controller 150 may control the inverter circuit 430 based on the operation setting of the heating coil 434 (1200). The operation setting of the heating coil 434 may include a heating intensity setting for a cooking zone corresponding to the heating coil 434.

In an embodiment, the controller 150 may determine switching frequencies of the upper switching element 431a and the lower switching element 431b based on the operation setting of the heating coil 434, and may operate the upper switching element 431a and the lower switching element 431b in a complementary manner according to the determined switching frequencies.

For example, the user may select a heating intensity of the cooking zone corresponding to the heating coil 434 through the input device 130.

Once the input device 130 receives a selection of an heating intensity from the user, the controller 150 may determine the switching frequencies of the upper switching element 431a and the lower switching element 431b based on the selected heating intensity.

The controller 150 may alternately turn on/off the upper switching element 431a and the lower switching element 431b based on the switching frequency corresponding to the heating intensity selected through the input device 130, thereby applying a high frequency current having a frequency corresponding to the selected heating intensity to the heating coil 434.

For example, the switching frequencies of the upper switching element 431a and the lower switching element 431b may be determined to be 20 kHz to 35 kHz depending on the operation setting of the heating coil 434.

In the disclosure, as such, the first switching element 443a and the second switching element 443b of the PFC circuit 440 may be operated based on a preset switching frequency, and the upper switching element 431a and the lower switching element 431b of the inverter circuit 430 may be operated based on the operation setting of the heating coil 434.

In addition, the switching frequencies of the first switching element 443a and the second switching element 443b of the PFC circuit 440 may be operated at a preset optimal switching frequency regardless of the operation setting of the heating coil 434. In this instance, the optimal switching frequency may be set to a frequency suitable for smoothing the AC voltage rectified by the rectifier circuit 420.

In addition, the switching frequencies of the first switching element 443a and the second switching element 443b of the PFC circuit 440 may be determined based on the operation setting of the heating coil 434.

According to the disclosure, the PFC circuit 440 including at least two inductors and two switching elements may be provided between the rectifier circuit 420 and the inverter circuit 430, thereby providing a smoothed voltage to the heating coil 434.

As a result, according to the disclosure, magnetic noise generated during operation of the heating coil 434 may be reduced.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

In addition, the computer-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a “non-transitory storage medium” may include a buffer in which data is temporarily stored.

According to an embodiment, the methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, those skilled in the art will appreciate that these inventive concepts may be embodied in different forms without departing from the scope and spirit of the disclosure, and should not be construed as limited to the embodiments set forth herein.

1. An induction heater, comprising:
a heating coil;
a rectifier circuit configured to rectify an alternating current input power;
a power factor correction (PFC) circuit connected to the rectifier circuit;
a direct current (DC) link capacitor connected to the PFC circuit; and
an inverter circuit connected to the DC link capacitor, and configured to apply a drive current to the heating coil,
wherein the PFC circuit comprises:
a first inductor connected to an output node of the rectifier circuit;
a second inductor connected to the output node of the rectifier circuit and connected in parallel with the first inductor;
a first diode connected to the first inductor and the DC link capacitor;
a second diode connected to the second inductor and the DC link capacitor;
a first switching element connected to the first inductor and a ground node; and
a second switching element connected to the second inductor and the ground node.

2. The induction heater of claim 1, further comprising:
a controller configured to control the first switching element and the second switching element.

3. The induction heater of claim 2, wherein the controller is configured to operate the first switching element and the second switching element to be complementary with each other, based on receiving a user input to turn on the induction heater.

4. The induction heater of claim 3, wherein the controller is configured to control the first switching element and the second switching element to allow a switching frequency to be 30 kHz or more.

5. The induction heater of claim 4, wherein the inverter circuit comprises an upper switching element and a lower switching element, and
the controller is configured to determine switching frequencies of the upper switching element and the lower switching element based on an operation setting of the heating coil, and operate the upper switching element and the lower switching element in a complementary manner according to the determined switching frequencies.

6. The induction heater of claim 1, wherein the DC link capacitor comprises a plurality of capacitors connected to each other.

7. The induction heater of claim 1, wherein the inverter circuit comprises an upper switching element, a lower switching element, an upper resonant capacitor and a lower resonant capacitor, and
the heating coil is connected between a common node of the upper resonant capacitor and the lower resonant capacitor and a common node of the upper switching element and the lower switching element.

8. The induction heater of claim 1, wherein an anode of the first diode is a common node of the first inductor, the first diode and the first switching element.

9. The induction heater of claim 1, wherein an anode of the second diode is a common node of the second inductor, the second diode and the second switching element.

10. The induction heater of claim 1, wherein the DC link capacitor is connected to a cathode of the first diode and the ground node.

11. The induction heater of claim 1, wherein the DC link capacitor is connected to a cathode of the second diode and the ground node.

12. The induction heater of claim 11, wherein the inverter circuit comprises:
an upper switching element connected to a cathode of the first diode or a cathode of the second diode and a first node; and
a lower switching element connected to the first node and the ground node.

13. A method for controlling an induction heater comprising:
rectifying, using a rectifier circuit, an alternating current input power, the rectifier circuit being connected to a power factor correction (PFC) circuit which is connected to a direct current (DC) link capacitor, the DC link capacitor being connected to an inverter circuit configured to apply a drive current to a heating coil,
operating a first switching element of the PFC circuit and a second switching element of the PFC circuit to be complementary with each other, based on receiving a user input to turn on the induction heater, the first switching element and the second switching element being connected to a ground node,
wherein the PFC circuit comprises:
a first inductor configured to be connected to an output node of the rectifier circuit, the first inductor being connected to the first switching element;
a second inductor connected to the output node of the rectifier circuit and connected in parallel with the first inductor, the second inductor being connected to the second switching element;
a first diode connected to the first inductor and the DC link capacitor;
a second diode connected to the second inductor and the DC link capacitor.

14. The method of claim 13, wherein the operating of the first switching element and the second switching element to be complementary with each other comprises controlling the first switching element and the second switching element to allow a switching frequency to be 30 kHz or more.

15. The method of claim 14, wherein the inverter circuit comprises an upper switching element and a lower switching element, and
the method further comprises:
determining switching frequencies of the upper switching element and the lower switching element based on an operation setting of the heating coil; and
operating the upper switching element and the lower switching element in a complementary manner according to the determined switching frequencies.
